(19) United States
(12) Patent Application Publication
(10) Pub. No.: US 2006/0032938 A1
(43) Pub. Date: Feb. 16, 2006

(54) Apparatus and method for powering irrigation system with solar power

(76) Inventor: Christopher Michael Pomey, Whitmore Lake, MI (US)

Correspondence Address: SEYFARTH SHAW LLP, 55 EAST MONROE STREET, SUITE 4200, CHICAGO, IL, 60603-5803, US

(21) Appl. No.: 10/941,532

(22) Filed: Sep. 15, 2004

Related U.S. Application Data
(60) Provisional application No. 60/600,857, filed on Aug. 12, 2004.

(51) Int. Cl. A01G 27/00

(52) U.S. Cl. 239/67

(57) ABSTRACT

A system including an irrigation system and a solar power assembly coupled to the irrigation system. Solar energy is received. The solar energy is utilized to charge at least one battery. The battery then provides power from the at least one battery to an irrigation controller.

### BACKGROUND

Irrigation systems, such as underground sprinkler systems, provide a time saving and convenient way to water lawns, landscaping, vegetation, and the like. A user simply programs the irrigation system to water a particular area at a particular time and then gives watering no more thought.

A difficulty arises, however, when the user does not have power to operate the irrigation system. For instance, in the construction industry, builders often install underground sprinkler systems and landscaping prior to a development actually having electrical power. Thus, even though an irrigation system is in place, it can not be utilized to water the landscaping. Further, after a building project is completed, the owner of the development may not wish to immediately provide electrical power to it (e.g. if there is no tenant). Yet, the plant life still needs to be maintained. Accordingly, the owner of the development will either have to retain someone to manually water the landscaping or will have to provide electricity to the entire development solely to utilize the sprinkler system.

Therefore, what is needed is an apparatus and method for powering an irrigation system through an alternate means, such as solar power.

### SUMMARY

In one embodiment, a system is provided. The system includes an irrigation system and a solar power assembly coupled to the irrigation system.

In one embodiment, a method is provided. Solar energy is received. The solar energy is utilized to charge at least one battery. The battery then provides power from the at least one battery to an irrigation controller.

In one embodiment, an apparatus is provided. The apparatus includes means for receiving solar energy, means for charging at least one battery with the solar energy, means for controlling an irrigation system, and means for providing power from the at least one battery to irrigation controlling means.

### BRIEF DESCRIPTION OF THE DRAWINGS

FIG. 1 is functional block diagram depicting one example of an irrigation system including a solar power assembly.

### DETAILED DESCRIPTION

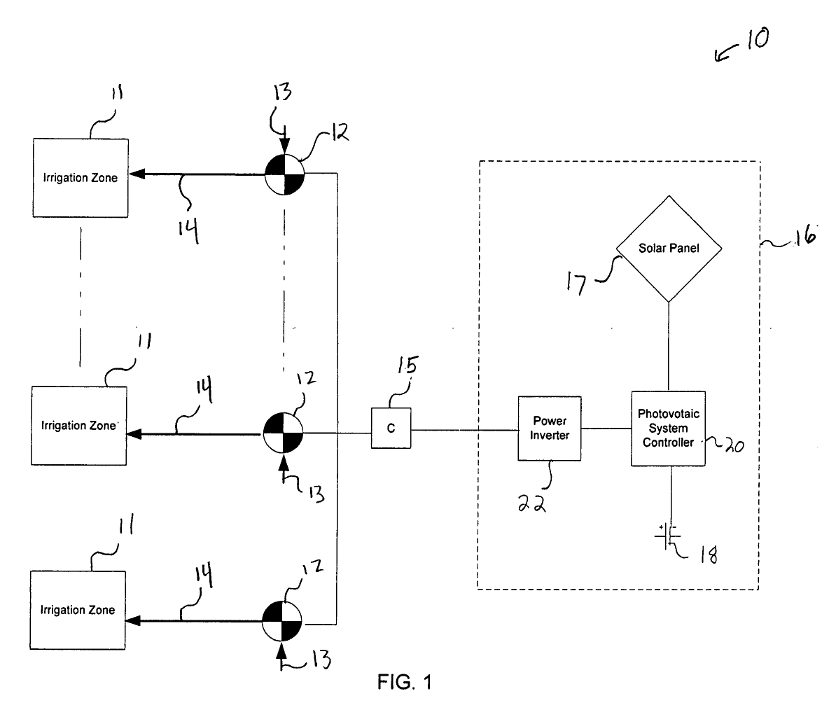

Referring to FIG. 1, in one example, an irrigation system 10 includes one or more valves irrigation zones 11, one or more valves 12, an irrigation controller 15, and a solar power apparatus 16.

Irrigation zones 11 are the particular areas that irrigation system 10 waters. Typically, an irrigation zone 11 will include a plurality of sprinkler heads, pop-ups, or other water distribution devices that are connected by plumbing. The particular number of irrigation zones and the particular design of each irrigation zone depends on the environment in which irrigation system 10 is used. The configuration shown in FIG. 1 is exemplary and provided for illustrative purposes only.

Valves 12 control the flow of water to irrigation zones 11. Typically each valve 12 includes an input 13 from a particular water source, such as a main line, and an output 14 that leads to the secondary lines, which feed a particular irrigation zone 11. In one example, valves 12 are solenoid valves, which are actuated by an electrical signal sent from irrigation controller 15. For instance, valves 12 could be of the kind that are actuated by receiving a 24 volts alternating current (VAC) signal from irrigation controller 15. It should be noted, however, that these values are described for exemplary purposes only and that other valves sufficient to function in accordance with the operating principles described herein are intended to be encompassed by this disclosure.

Irrigation controller 15 functions to actuate valves 12 by opening and closing them in accordance with user instructions. The instructions could be a predetermined watering schedule or could be a manual override. In one example, the irrigation controller 15 receives a 120 VAC operating input from the solar power apparatus 16 and outputs 24 VAC to valves 12. The irrigation controller 15 in this example includes a built in transformer to down convert the input power of 120 VAC to 24 VAC.

Solar power apparatus 16 powers irrigation system 10 through utilization of solar power. Solar power apparatus 16 in one example comprises at least one photovoltaic solar panel 17, at least one battery 18, a photovoltaic system controller (PSC), and a power inverter 22.

Solar panel 17 converts light from the sun into electricity and charges battery 18. There number of solar panels 17 utilized in solar power apparatus 16 depends on the environment in which irrigation system 10 resides. For instance, in an area of minimal sunlight, an array of solar panels 17 may be necessary to provide sufficient power to charge battery 18. In areas with a great deal of sunlight, only one solar panel 17 may be necessary to charge battery 18. Similarly, the size and type of solar panels also depends on the environment in which irrigation system. For instance, a user, for aesthetic reasons, a user may want to use many small solar panels than one large big solar panel, or due to the location, the solar panel 17 may have to be roof mounted, ground mounted or pole mounted.

In one example, solar panel 17 has 30 to 36 cells connected in series. Each cell produces about 0.5V in sunlight, so a 30 to 35 cell panel produces 15V to 18V. Solar panel 17 is mounted at the most effective angle to receive sunlight.

Battery 18 in one example is a 12 volt (V) battery. Battery 18, however, can be any battery suitable for use in a photovoltaic system. Examples include but are not limited to deep cycle nickel-cadmium and lead-acid batteries. Moreover, depending on the needs of the user, an array of batteries 18 can be used to power system 10.

PSC 20 in one example prevents battery 18 from overcharging. This is necessary because depending on the output of solar panel 17, battery 18 could overcharge and then reverse current, thereby damaging solar panel 17. For example, a 30 cell solar panel (15 V) can charge a 12 V battery without a controller, but it might not charge the battery completely. In contrast, a 36 cell solar panel (18 V) will charge battery 18 completely, but it will require a controller 10 to prevent overcharging. PSC may also include a discharge controller to prevent battery 18 from having an excessive discharge and thereby rendering system 10 powerless.

Power inverter 22 receives DC power from battery 18 and converts it to VAC. In one example, power inverter 22 receives 12 VDC from battery 18 and converts it to 120 VAC. Power inverter sends the VAC power to irrigation controller 15, which utilizes it to open and close valves 12 in accordance with the user's instructions.

As stated earlier, the irrigation controller 15 in one example requires 120 VAC to operate and outputs 24 VAC to actuate valves 12. This 24 VAC is not a constant draw but rather a short burst to open and close each valve 122. A typical commercial system may have anywhere from 10 to 50 zones, but because there is no constant draw the system can accommodate many valves and zones.

From a physical design standpoint, solar panel 17 should be mounted at the most effective angle to receive maximum sunlight in the environment in which the irrigation system 10 is present. For example, it might be necessary to install solar panel 17 on a roof, the ground, a pole, etc. The battery 18, photovoltaic system controller 20, and power inverter 22 can be mounted near the irrigation controller 15, which is usually in a secure area, such as a building.

The preceding description was provided for exemplary purposes only. There are many different variations of the system described above that are within the scope of the present disclosure. For example, there are many different sizes and types of solar panels 17 that can be chosen to fit the needs of a particular end user. One consideration when choosing the solar panel 17 will be amount of sunlight the particular area receives during a particular time of the year. It may be necessary to use multiple panels or an array of panels to generate sufficient power.

Similarly, the photovoltaic controller 20 can be chosen according to the needs of the end user. An exemplary controller 20 will be equipped with terminals for the solar panel 17, the battery 18, and the load (inverter) 22, and be rated for 12 V or 24 V systems. There are different controllers for different amp outages and thus the controller 20 should be sized for the systems peak power.

The inverter 22 should also be sized according to the system. In one example, the inverter 22 will have a low battery shut down to prevent the battery from draining all the way, for example when there is are multiple cloudy days and the solar panel 17 can not provide enough charge.

Batteries 18 should be chosen using location as a factor. If a climate or region does not have many sunny days or the time of year does not allow for multiple sunny days, multiple batteries 18 should be included in the system. For example, two 12V batteries could be wired together to increase the power to 24V (the other components would also be scaled up accordingly) and provide longer battery life.

The matter set forth in the foregoing description and accompanying drawing is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A system, comprising:
an irrigation system; and
a solar power assembly coupled to the irrigation system.

2. The system of claim 1, wherein the irrigation system is a lawn or landscaping irrigation system.

3. The system of claim 2, wherein the lawn or landscaping irrigation system is an underground sprinkler system.

4. The system of claim 1, wherein the irrigation system comprises:
at least one valve; and
an irrigation controller coupled to the at least one valve.

5. The system of claim 1, wherein the solar power assembly comprises:
at least one solar panel; and
at least one battery coupled to the at least one solar panel.

6. The system of claim 5, wherein the solar power assembly further comprises:
a photovoltaic system controller coupled between the at least one solar panel and the at least one battery.

7. The system of claim 6, wherein the solar power assembly further comprises:
a power inverter coupled to the photovoltaic system controller.

8. The system of claim 7, wherein the irrigation system comprises:
an irrigation controller; and
at least one valve coupled to the irrigation controller; wherein the power inverter supplies power to the irrigation controller.

9. A method for powering an irrigation system, comprising:
receiving solar energy;
utilizing the solar energy to charge at least one battery; and
providing power from the at least one battery to an irrigation controller.

10. The method of claim 9, wherein the step of receiving solar energy comprises receiving solar energy through employment of at least one photovoltaic solar panel.

11. The method of claim 9, wherein the step of utilizing the solar energy comprises:
applying a charge to the at least one battery when the battery is not fully charged, and
removing the charge from the at least one battery when the battery is fully charged.

12. The method of claim 9, wherein step of utilizing the solar energy comprises utilizing the solar energy to charge a 12 V battery

13. The method of claim 12, wherein the step of providing the power from the battery to the irrigation controller comprises inverting the power from the 12 V battery to 120 VAC.

14. The method of claim 13, wherein the step of providing further comprises converting the 120 VAC to 24 VAC.

15. The method of claim 9, wherein the irrigation controller utilizes the power to actuate a valve.

16. A solar power assembly, comprising:
means for receiving solar energy;
means for charging at least one battery with the solar energy; and
means for providing power from the at least one battery to irrigation controlling means.

17. The solar power assembly of claim 16, wherein the means for receiving solar energy comprises at least one photovoltaic solar panel.

18. The solar power assembly of claim 16, wherein the means for charging the solar panel comprises:
means for applying a charge to the at least one battery when the battery is not fully charged and removing the charge from the at least one battery when the battery is fully charged.

19. The solar power assembly of claim 16, further comprising a 12 V battery coupled to the charging means.

20. The solar power assembly of claim 19, wherein the providing means comprises means for inverting power from the 12 V battery to 120 VAC.

21. The solar power assembly of claim 16, further comprising means for controlling an irrigation system.

22. The apparatus of claim 20, wherein the irrigation system controlling means comprises means for converting the 120 VAC to 24 VAC.

23. The apparatus of claim 9, wherein the irrigation system controlling means comprises means for actuating a valve through utilization of the 24 VAC power.
